(19) United States
(12) Patent Application Publication
(10) Pub. No.: US 2008/0309021 A1
(43) Pub. Date: Dec. 18, 2008

(54) Packing Seal and Piston Comprising Such a Packing Seal

(76) Inventor: Hans Helpap, Pliening (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 11/915,274

(22) PCT Filed: May 18, 2006
(86) PCT No.: PCT/DE2006/000864

§ 371 Date: Jul. 2, 2008

(30) Foreign Application Priority Data
May 23, 2005 (DE) 10 2005 024 140.9

(51) Int. Cl. F16J 9/24; F16J 9/12

(52) U.S. Cl. 277/446; 277/493

(57) ABSTRACT

A packing seal for the piston of a reciprocating engine can be inserted into a circumferential groove of the piston and is provided with three segment rings that adjoin each other in an axial direction, i.e. a second (lower) segment ring, a first (top) segment ring thereabove, and a conical pressure securing ring above the first segment ring. The second (lower) segment ring is characterized in that the ends of the seal segments and the lock parts which adjoin each other in the peripheral direction radially engage behind one another in a hook-like manner, the seal segments being provided with an inward-pointing hook and the lock parts being equipped with an outward-pointing hook.

The invention relates to a sealing pack and to a reciprocating piston for reciprocating piston engines according to the preamble of claim 1 and claims 13 and 14 respectively.

WO 95/14184 discloses a sealing pack for reciprocating pistons of a reciprocating piston engine which comprises at least two axially adjoining segmented rings of the same design which are each composed in alternation of at least two sealing segments and as many locking parts. These sealing segments and locking parts each taper in opposite directions radially inwards and outwards respectively in the form of a wedge in both segmented rings, with the “ideal” wedge vertices of the sealing segments always pointing towards the central axis of the ring and those of the locking parts always pointing in the direction of the cylinder wall. The axially adjoining segmented rings are rotated in relation to one another so that the sealing segments overlap in their contact with the cylinder wall and radially extending free spaces between the sealing segments are occupied and closed by the locking parts. Finally, a rotation-preventing locking device between in each case at least one segment of the successive segmented rings prevents displacement of the sealing segments relative to one another. A ring pressure spring which is also placed in the bottom of the piston ring groove exerts an additional force on the sealing pack so as to guarantee the formation and maintenance of the sealing boundary.

EP 937 216 B1 (WO 98/08009) describes an improved sealing pack which from the design standpoint makes it possible to dispense with the use of the necessary pressure spring according to WO 95/14184 without a replacement. Due to the position of the first upper segmented ring, in particular during the movement of the piston and sealing pack from “top dead centre” TDC towards “bottom dead centre” BDC, there is a danger of a reduced supply of sealing oil in the sealing and moving gap between the wall of the cylinder and the sealing segments of the first upper segmented ring. Particularly at higher piston speeds, this results in free spaces in the sealing gap in which the forces coming into play arise no longer from the physical principle of “pressure conversion” but through the direct action of the gas pressure on the surfaces of the free space.

Consequently, it is necessary to apply an additional “force” effectively directed towards the cylinder wall in order to counteract the possible build up of the forces acting in the direction of the “central axis of the piston” at the sealing segments and to avoid the collapse of the sealing boundary.

With this known sealing pack a first upper segmented ring is used which (equally) is composed of at least two wedge-shaped sealing segments and as many wedge-shaped locking parts which alternate in their contact and the ideal wedge angle vertices of which are always aligned in the direction of the central axis of the piston. Apart from this, the outer arc generated by the locking parts not in contact with the cylinder wall is always larger than the arc of the sealing segments in contact with the cylinder wall which only overlap with the sealing segments of the second lower segmented ring as far as necessary. Provided above this there is a so called thrust and locking ring which is also wedge-shaped in cross section and has at least one transverse slot and lies between the upper segmented ring and the part of the piston grove corresponding to the thrust ring. This so-called thrust and locking ring has the function firstly of as far as possible preventing the sealing pack lifting off the lower contact face on the wall of the piston ring groove when high mass accelerations occur, and secondly of covering the radial contact gap between the individual ring segments in the first upper segmented ring and thus reducing an undesired pressure build up in the interspaces of this contact gap.

However, it has been shown that when this sealing pack is used, the expected performance improvements are only attainable to a limited degree. Apart from this, it must be said that the sealing segments of the second lower segmented ring are subject to increased wear. Even with excellent sealing capacity with very good leakage values, this reduces the general area of use and application of the sealing pack at best to special variants. The causal relationships of these disqualifying functional characteristics arise from the specific design of the segmented rings which are a determining factor with this kind of sealing pack.

The axially acting sealing boundary of the sealing pack is formed by the overlapping sealing segments of the first upper segmented ring and the at least one second lower segmented ring which lie one above the other and are prevented from rotating in relation to one another in a ring groove in a reciprocating piston. The locking parts which correspond to the sealing segments in the thickness of the material, each close the free spaces existing between two sealing segments and thus form a radially extending sealing boundary in the second lower segmented ring which comes into effect both in relation to the first upper segmented ring and also in relation to the contact with the piston ring groove. This radially acting sealing boundary is guaranteed in particular by the individual segments of the at least two segmented rings which are different but still wedge-shaped. Here, the locking parts are set back slightly in their outer boundary relative to the sealing segments in contact with the cylinder wall so that automatic adjustment is allowed when wear occurs. As working pressure develops in the operating space—and hence in the bottom of the groove, a build up of force is initiated at the respective individual segments which in the second lower segmented ring is as a rule aligned radially to the wall of the cylinder. The locking parts which only bear on the sealing segments tangentially, can only transmit their working force resulting from the working pressure to the two adjoining sealing segments. This means that generally—particularly in the second lower segmented ring—a second force component is built up at the sealing segments in addition to their own working force, which leads to increased contact pressure of the sealing segments on the cylinder wall and should thus be the main cause of the increased wear.

U.S. Pat. No. 2,055,153 discloses a sealing pack which consists of two segmented rings the ends of which grip vertically behind each other, so that a specific design of slot is present in the ring. However, this does not exhibit a clearly defined functional design with adjoining sealing segments with a locking part (not adjoining) positioned between them which form a radially closed segmented ring and when rotated at a predetermined angle also form a closed “assembly” in the axial direction when two segmented rings are laid one over the other.

U.S. Pat. No. 2,590,961 and DE 523 160 C each describe a single piston ring which has a single slot and the slot location of which is provided with a locking part which fits in vertically. This appears to be capable of reducing the gas leakage to a limited degree at certain times, but the complete formation of a sealing boundary is not possible.

Finally, GB 2 131 121 A discloses a piston ring which also has only a single slot and the ring ends of which can be hooked together, so that the gas leakage is reduced. This hooked connection does not offer a permanent closed sealing boundary in the radial and axial direction.

Thus, the object of the invention is to disclose a sealing pack of the kind named above with which the frictional losses are limited to minimal values by the piston sealing system in a simple manner and at the same time good sealing characteristics are guaranteed. In addition, a reciprocating piston for a reciprocating piston engine is disclosed which produces optimum sealing and oil control properties and minimal frictional losses using this sealing pack.

This object is achieved through a sealing pack with the features of claim 1. Advantageous developments are characterised in the correspondingly related subordinate claims.

Accordingly, the ends of the sealing segments and locking parts of the second lower segmented ring adjoining one another in the circumferential direction are designed so that they grip behind one another in the form of hooks such that the sealing segments have a hook part which points radially inwards, and the locking parts have a hook part which points radially outwards, through which the wedge faces of the two types of segment coming to bear on one another and transmit force each point towards their own segment central axis. Thus, a common hooking bearing face is formed between the ends of the locking parts and the sealing segments which can be considered and defined as part of a straight portion. This proves to be particularly advantageous when transmitting the locking part forces to the sealing segments and thus to the formation of the second working component at the sealing segments, which is explained in detail in the following in connection with FIG. 5.

The locking parts are also designed so that starting from the respective line of the overlapping individual hooking face, the inner boundary diameter is extended as specified and the outer boundary diameter between the two (hooking) shoulders can be produced as a direct connection. With a design in this form, segmented rings can be produced which form a completely closed sealing boundary in the radial direction and an almost closed sealing boundary in the axial direction. The greatest part of the sealing boundary coming into effect axially is thus produced through the sealing segments of the second lower segmented ring. It is only in the length of the arc that small breaks in the ring corresponding numerically to the pitch angle, have to be covered by the sealing segments of the first upper segmented ring which is constructed according to the state of the art as defined by EP 987 216 B1. Thus, the frictional forces occurring at the sealing segments of the first upper segmented ring can be optimised by means of design criteria which can be predetermined constructively (angular position and effective direction) in such a way that the contact forces (and hence the frictional forces) of the complete sealing pack can be reduced to a necessary minimum sufficient for formation of the sealing boundary.

It is advantageous when the segmented rings located axially one above the other are provided with a rotation-preventing locking device in the form of a tongue and groove connection on the inside circumference of the segmented rings, expediently at the locking part of one segmented ring and at the sealing segment of the other segmented ring. Here, it is possible to use the larger segmented rings for this in each case, i.e. here the sealing segment in the case of the lower ring and the relatively long locking part in the case of the ring lying above it. The respective grooves and the associated key holding the two segments together so that they cannot rotate are designed so that the key fits freely in the piston groove.

According to one preferred form of embodiment, each segmented ring comprises four locking parts and four sealing segments. The respective radial alignment of the contact faces of the segment parts allows a design of the sealing pack which works reliably and can be produced and manufactured inexpensively. Naturally, the invention is not limited to this preferred number of rings and segments, but this number also depends on the dimensions and sizes of the respective segmented rings.

As in the case of the state of the art as described previously, it is advantageous when the sealing pack according to the invention is also provided with a thrust and locking ring which tapers inwards conically at its upper side and consists of at least two ring halves and can also exhibit surface breaks in its contact surface on the underside for axial pressure relief. The thrust and locking ring limits—even if it does not prevent—undesired tilting of the individual segments so that the sealing boundary assembly of the sealing pack is maintained in all operating conditions in a stable and reliable manner.

As the second lower segmented ring can be designed so that the partial sealing boundary areas coming into effect axially form an almost closed circle, in a further advantageous variant it is possible to form the conventional oil control ring of the reciprocating piston as a segmented ring as well and integrate it into the sealing pack as the lowest segmented ring. This results in a completely new kind of sealing pack which performs both functions, namely the sealing function and the oil control function. This brings the particular advantage that one less groove has to be formed in the reciprocating piston.

According to one preferred form of embodiment, the oil control segmented ring comprises the same number of locking parts and sealing segments as the similarly designed second lower segmented ring of the sealing pack described previously, i.e. in each case four parts and four segments. The ends of the adjoining ring segments pointing in the circumferential direction grip behind one another radially again in the form of a hook, with the reciprocal hook contact faces and hence the straight contact lines aligned radially to the centre point of the ring.

Advantageously, the locking parts are embodied as U-shaped coupling elements which with their hook limbs pointing towards the wall of the cylinder engage radially from the inside outwards in corresponding hook recesses in the oil control segments pointing towards the centre point of the ring, with the outer circumferential end faces of the oil control segments or their hook parts also pointing radially towards the central axis of the ring and at the same time maintain a tiny radial gap essentially parallel with one another. Thus, here as well the force and operating conditions can also be designed in a similar way as in the case of the lower second segmented ring of the sealing pack described previously, i.e. the sealing segments can be held in almost pressureless contact with the wall of the cylinder, so that the frictional losses are reduced to a minimum while maintaining the oil control effect of the ring. For this is it advantageous when the oil control segments of this ring are bevelled on their generated surface facing the wall of the cylinder so that they widen conically downwards towards the bottom dead centre (BDC) position of the reciprocating piston in a manner known per se.

Apart from this, the boundary faces of the locking parts of the oil control segmented ring which are aligned (pointing tangentially) facing away from the central vertices, are formed radially so that their straight lines form a wedge aligned with the ideal angle vertex towards the axis of the piston and the oil control segments corresponding to this radially aligned pattern also form an angle pointing with the ideal vertex of the wedge towards the central axis of the piston and the straight lines of which exhibit a defined gap in relation to the straight lines of the respective contact faces of the locking parts. This functional design corresponds to the operating principle of transmitting force from the locking part to the sealing segment in the upper first segmented ring, which is the state of the art according to EP 987 216 B1. This guarantees that surplus oil is scraped off the wall of the cylinder even in the course of an induction operation when a vacuum prevails in the operating space.

It is expedient, but not absolutely necessary, to include the oil control segmented ring when defining the relative positions in this sealing pack with the at least four segmented rings. For this, one of the sealing segments of the oil control ring must be provided with a groove which corresponds with the grooves of the two segmented rings lying above it and into which is placed a common key which is taller and designed accordingly for the height of the three segmented rings. However, it must be recognised that this additional oil control ring in the (four-element) sealing pack need not necessarily exhibit a defined position in relation to the two segmented rings performing a sealing function located above it since it does not affect their sealing function.

The object is also achieved through a reciprocating piston for a reciprocating piston engine according to claim 13 which exhibits at least one sealing pack according to claims 1 to 6 and claim 12 and at least one conventional oil control ring located in its own piston groove.

Finally, according to claim 14, a reciprocating piston for a reciprocating piston engine is provided which exhibits at least one sealing pack according to claims 7 to 12, i.e. in which a four-element sealing pack, i.e. a sealing pack incorporating an oil control segmented ring as the fourth lowest ring, is provided in just one piston groove.

In the following, the invention is described in greater detail on the basis of a plurality of embodiment examples with reference to the drawing in which:

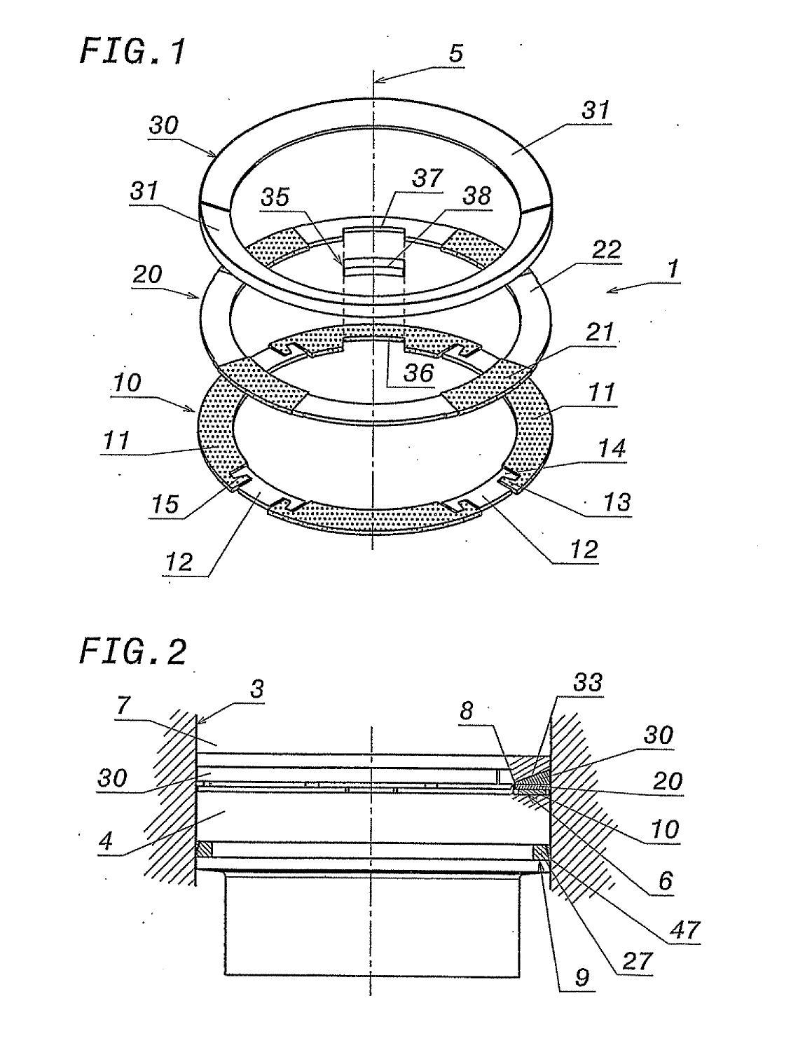

FIG. 1 shows an exploded perspective illustration of the segmented rings of the sealing pack in a first embodiment with three segmented rings;

FIG. 2 shows a radial sectional view of a reciprocating piston with a sealing pack according to FIG. 1;

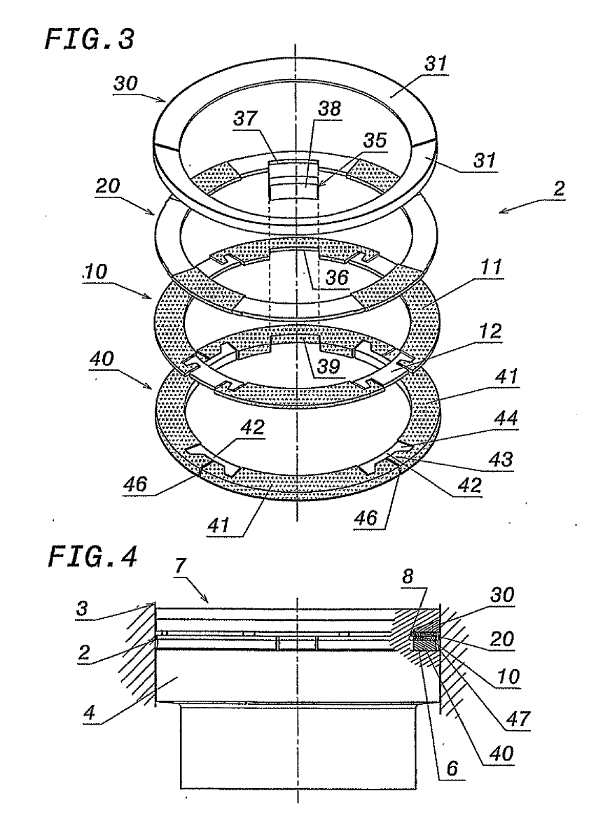

FIG. 3 shows an exploded perspective illustration of the segmented rings of the sealing pack in a second embodiment with four segmented rings, i.e. with an integral oil control ring;

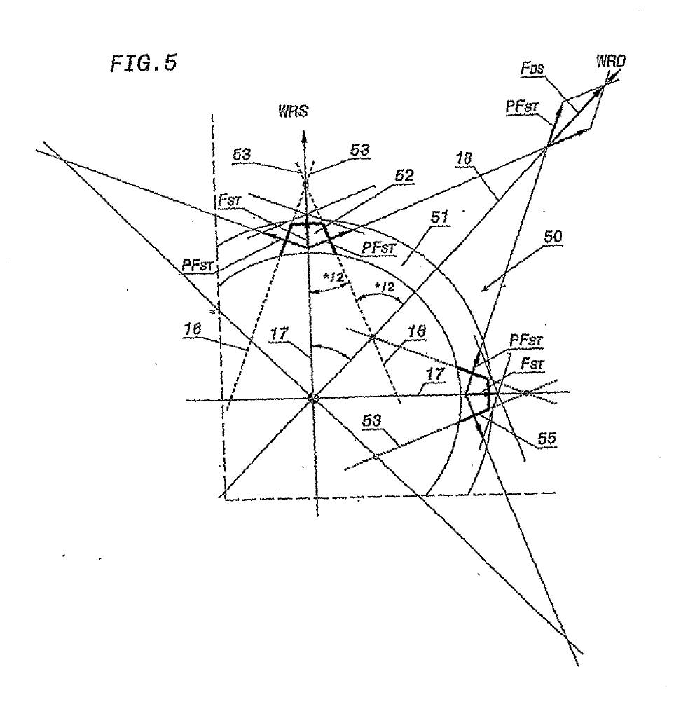

FIG. 4 shows a radial view of a reciprocating piston with a sealing pack according to FIG. 3;

FIG. 5 shows a diagrammatic illustration of a detail of a first lower segmented ring of a sealing pack according to the state of the art, showing the effective forces;

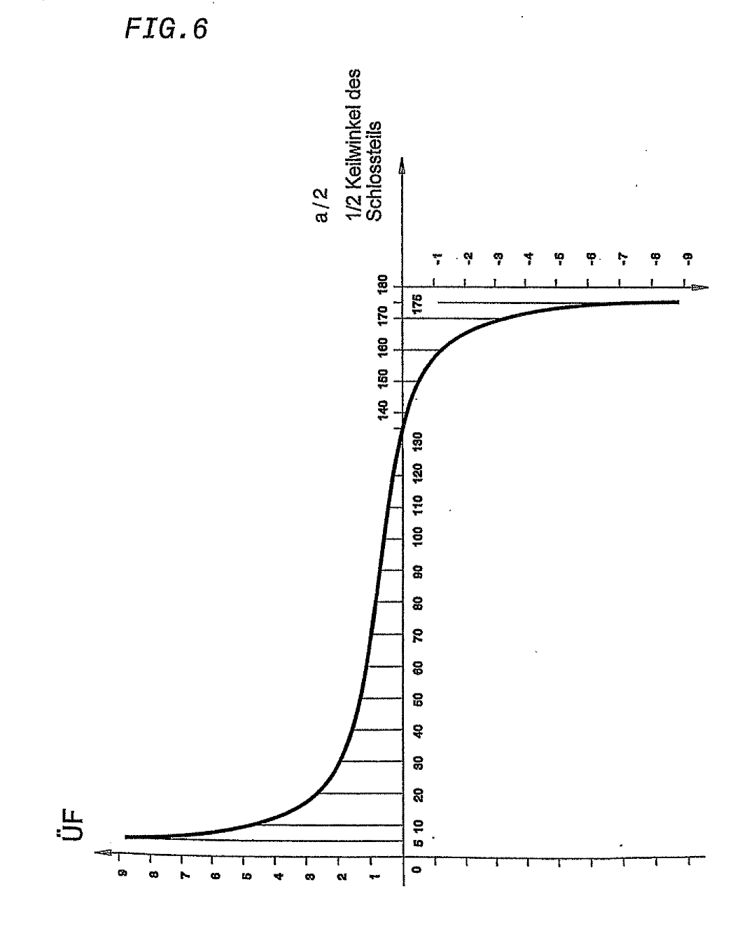

FIG. 6 shows the graph of the transmission factor TF;

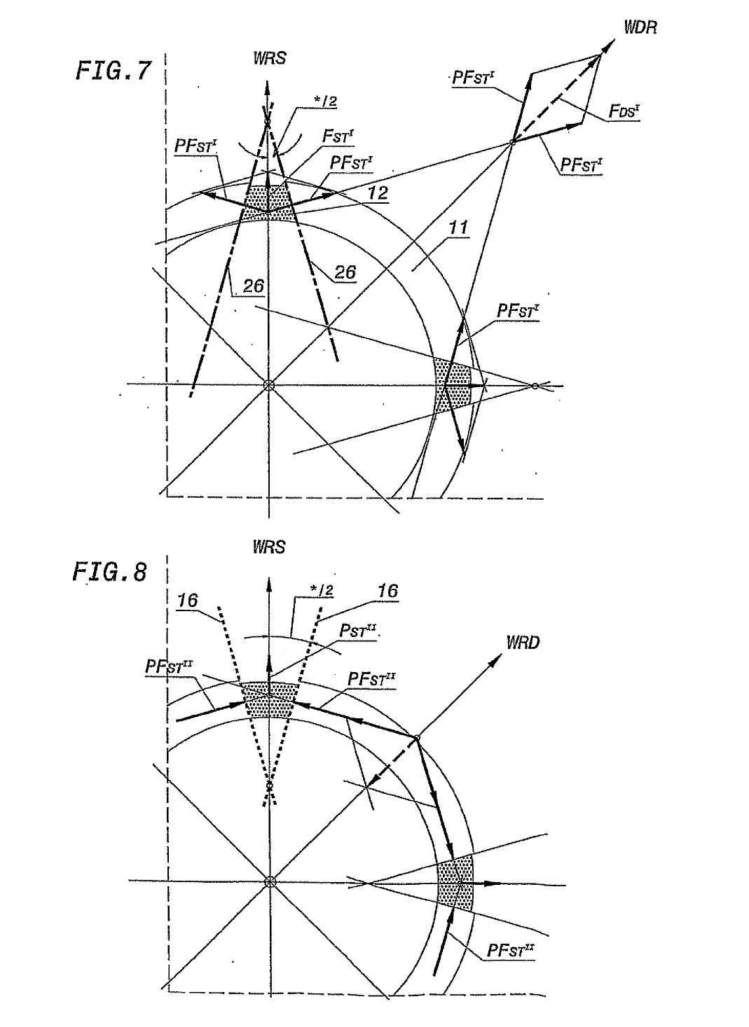

FIG. 7 shows a diagrammatic illustration of the partial force graph for the effective force acting on the locking part depending on the respective effective direction;

FIG. 8 shows a detail of a second lower segmented ring, showing the forces;

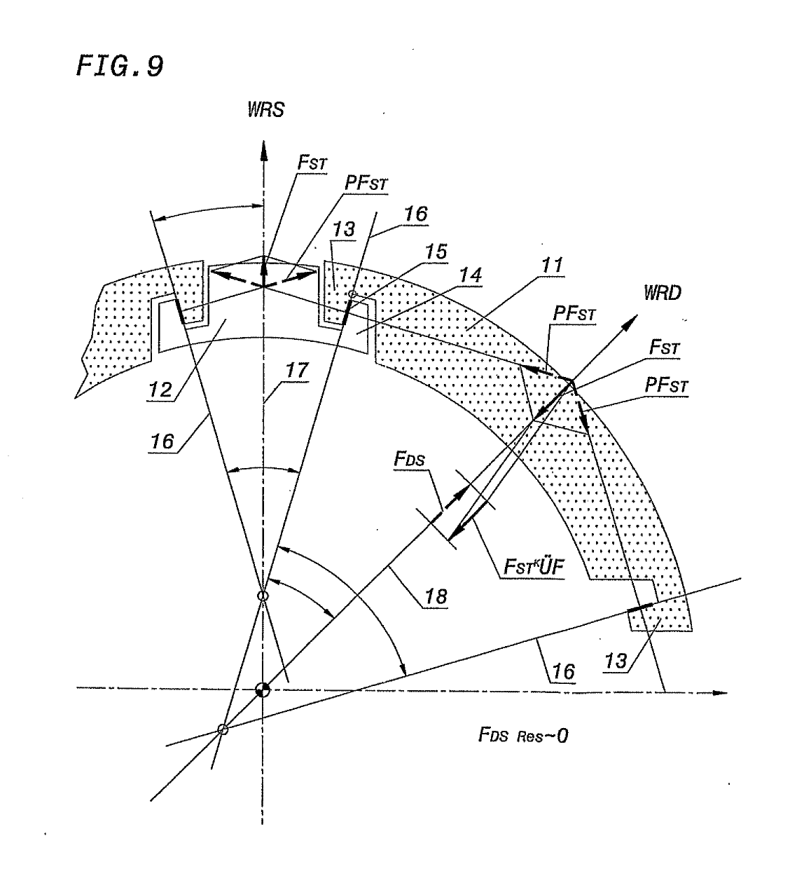

FIG. 9 shows a plan view of an oil control segmented ring of the sealing pack according to FIG. 3;

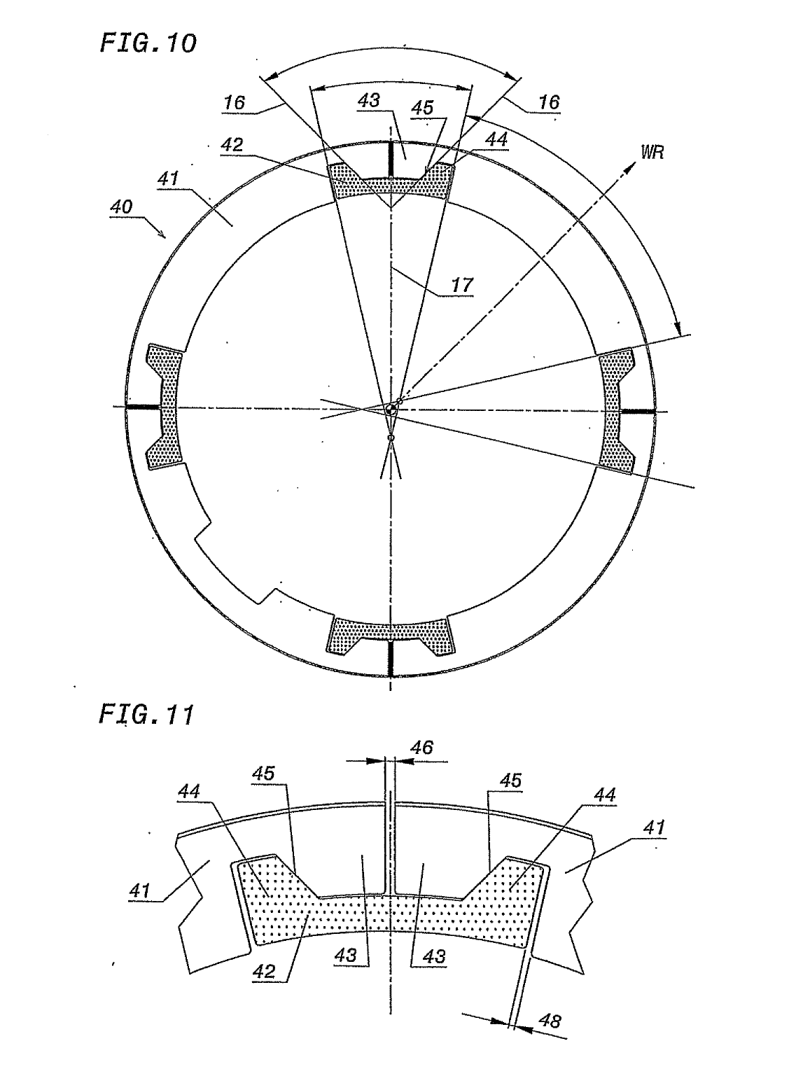

FIG. 10 shows a detail of the oil control ring according to FIG. 9.

As can be seen from FIGS. 1 and 2, a sealing pack 1 according to the invention consists in a first embodiment of three rings arranged axially in succession, namely a second lower segmented ring 10, a first upper segmented ring 20 and a thrust and locking ring 30.

FIG. 1 shows how the second lower sealing segmented ring 10, which exhibits the essential features of the invention, is composed of a plurality of sealing segments, here in each case of four sealing segments 11 and as many locking parts 12. At their neighbouring ends in the circumferential direction the sealing segments 11 and the locking parts 12 exhibit hook-shaped structures with contact faces 15. Thus, the sealing segments 11 exhibit two inwardly pointing hooks 13 the hooking faces of which each point towards the central axis of the sealing segment and engage in corresponding outwardly pointing hooks 14 of the locking parts 12 the hooking faces of which point towards the central axis of the locking part. Here, the two cooperating hooks 13, 14 are in contact through their contact faces 15 through which force is transmitted from one segment to the other. The locking parts 12 are arranged set back radially inwards in relation to the external circumference of the sealing segments 11. This avoids the locking parts 12 touching an opposing sealing face to be sealed which in the sectional illustration in FIG. 2 is formed for example by a cylinder wall 3 of a piston engine not shown. The central axis 5 of the sealing pack 1 is as axial reference both the central axis of all the segmented rings forming the sealing pack and that of the cylinder 3 and the piston 4 of the reciprocating piston engine; a definition of radial dependence relates primarily to the line of the central axis of a ring segment. The hook contact faces of the sealing segments 11 and the locking parts 12 in each case point radially towards their own central axis. As a result, the touching or sliding faces (contact faces) 15 which widen radially outwards with a wedge shape, are formed between the respective sealing segments 11 and locking parts 12. Further design and in particular effective details are to be found in FIG. 8 which shows an enlarged detail of this first lower segmented ring.

The first upper segmented ring 20 also has sealing segments 21 and locking parts 22 in an alternating arrangement. Here again, the locking parts 22 are arranged set back radially inwards in relation to the external circumference of the sealing segments 21. In addition, with this segmented ring this also avoids the locking parts 22 touching an opposing mating face to be sealed. The locking parts 22 extend over a larger arc than the sealing segments 21. The extent of the arc of the locking parts 21 is essentially predetermined by the fact that the extent of the arc of the respective sealing segments 21 must be such that in the case of the axially adjoining lower segmented ring 10, its locking parts 12 are reliably covered. In relation to the central axis 5, the sealing segments 21 and the locking parts 22 again taper in one and the same direction, namely in the radially inward direction, in comparison to the sealing segments 11 and locking parts 12. However, due to the existing wedge face formation, the partial forces of the locking parts 22 are transmitted to the sealing segments 21 so that these make reliable contact on the wall of the cylinder.

35 denotes as a whole a rotation-preventing locking device which consists of a tongue and groove connection which is provided on the circumference of the segmented rings 10 and 20 and consists firstly of a groove 36 in one of the sealing segments 11 of the lower segmented ring 10, a groove 37 in one of the locking parts 22 of the first segmented ring 20 and of a key 38 which engages in both grooves.

Lastly, the sealing pack 1 exhibits a third ring, the thrust and locking ring 30, which consists of at least two ring segments 31 which have the shape of a wedge when viewed in axial section and taper towards the central axis. This thrust and locking ring 30 has the function of maintaining the integrity of the sealing pack 1 and in particular of limiting any movement of the segmented rings 10 and 20 of the sealing pack 1 in the axial direction. In particular, this prevents any radial sealing boundary formed for contact in the piston ring groove from breaking down due to a tilting movement of the segment portions of the segmented rings through the action of mass and frictional forces of the sealing segments 11 and 21. The thrust and locking ring 30 can move depending on the working pressure such that the assembly gap and the axial clearance become smaller.

As can be seen in FIG. 2, the sealing pack 1 is placed in a circumferential piston ring groove 6 of a piston 4. The piston 4 performs a reciprocating movement in an upper working space 7, the working space 7 being bounded by the cylinder wall 3 in relation to which sealing is to be carried out according to the invention by means of the sealing pack 1. The sealing pack 1 is inserted in this circumferential groove 6 with the rotation-preventing locking device fitted (not shown here), so that an interspace is present between the bottom 8 of the groove and the inside of the segmented rings 10 and 20. In the cylinder 4, a conventional slotted oil control ring is provided at the bottom in an annular groove 9.

FIG. 3 shows a second sealing pack 2 in which a further bottom segmented ring, the oil control segmented ring 40, is present in addition to the three segmented rings described in connection with the sealing pack 1, namely the lower second segmented ring 10 with the hook-shaped segment ends, the upper first segmented ring 20 and the tapering thrust and locking ring 30 arranged above it. In this form of embodiment, this segmented ring 40 has four oil control segments 41 which abut one another in the circumferential direction except for a tiny radially pointing gap 43, and are held together or in contact by locking parts 42, like the locking parts of the lower second sealing segmented ring 20. However, these locking parts 42 do not extend as far as the external circumference of the segmented ring 40, but exhibit a flat U-shape and engage with their outwardly pointing segment hooks 44, with contact faces running radially to the central axis of the segment, in inwardly pointing segment hooks 43 which also have contact faces running radially to the central axis. The oil control segmented ring 40 also cooperates with the rotation-preventing locking device 35, for which it exhibits on its inside circumference a groove 39 which is identical in form to the grooves 35 and 36 of the segmented rings 10 and 20. Here, the key 38 engaging in these grooves is naturally taller by the height of the oil control segmented ring 40.

Further details on the design of the oil control ring 40 are to be found in FIG. 9.

FIG. 4 shows the arrangement of the sealing pack 2 visible in FIG. 3 in the piston ring groove 6 which here is taller by the thickness of the oil control segmented ring 40. However, here the piston 4 is simpler overall since there is no additional separate ring groove for an oil control ring.

To show the forces which are effective at the segments of the second lower segmented ring of the known sealing pack according to EP 0 937 216 B1, FIG. 5 only shows this ring diagrammatically in a detail. This segmented ring 50 consists of four sealing segments 51 with interposed locking parts 52 which taper in opposite directions radially inwards and outwards with a wedge shape. Here, the sealing segments 51 taper radially inwards and the locking parts 52 taper radially outwards. The force F_{ST} acting in the direction of the vertex of the wedge at a locking part 52 here is transmitted through its partial forces PF_{ST} to the adjoining faces of the sealing segment 51. At the sealing segment 51, the partial forces PF_{ST} form a new pressure force F_{DS} which acts in addition to the gas pressure force and can be a multiple of the original locking part force. The transmission factor TF of the locking part forces to the sealing segment 51 is dependent on the form of the contact face 55 which is determined and defined by the path of a (contact) straight line 16 and which in its path intersects the central axis 17 of the locking part 52 and the central axis 18 of the sealing segment 51. The resulting intersection angles have a decisive influence on the form of the respective partial forces and their adjustment.

FIG. 6 shows the graph of the transmission factor TF of the locking part force as a second force component acting at the sealing segment. As the wedge angle of the locking part increases, the second force component which acts at the sealing segment in the direction of the wall of the cylinder and has to be overlaid with the primary force resulting from the working pressure, is reduced. From a certain angle value a change in direction occurs in the direction of action of this second force component and theoretically the primary working force applied at the sealing segment can be excluded completely.

The conclusions to be drawn from the graph according to FIG. 6 are explained and supported by the illustrations in FIGS. 7 and 8 which show that the partial forces PF_{ST} of the locking part 12 take effect firstly as compressive forces with transmission angles up to the value π and secondly as tensile forces at the sealing segments with transmission angles which go beyond this. The direction of action of the second force component (F_{ST(I+II)}×TF) which has to be overlaid with the gas pressure force F_{DS(I+II)} applied at the sealing segment 11 runs accordingly dependent on this.

Thus, these illustrations (FIGS. 7 and 8) are to be used as the starting point for the design of the individual segments of the second lower segmented ring 10 according to the invention.

FIG. 9 shows a detail of the second lower sealing segmented ring 10 which, as described in connection with FIGS. 1 and 3, consists of four sealing segments 11 and as many interposed locking parts 12. Here, the adjoining ends of these segment parts 11, 12 engage in one another in the form of hooks, and the sealing segments 11 have sealing segment hooks 13 pointing radially inwards and the locking parts 12 have locking segment hooks 14 pointing radially outwards, and are effectively in contact through their contact faces 15 through which the radially pointing straight line 16 passes. The fact that the contact faces 15 of the locking parts 12 and sealing segments 11 pointing in each case towards their own central axis 17 and 18 respectively are hooked together and through this design feature the partial forces of the locking part 12 act as tensile forces on the sealing segment 11 allows the build up of a second force component which in its effect leads to the reduction of the pressure force with which the sealing segment 11 is pressed against the cylinder wall 3. In this way the frictional losses through the second lower segmented ring can be reduced to the absolute minimum necessary, even when the heat dissipation requirement is exacting.

FIG. 10 shows the oil control ring 40 which consists of four oil control segments 41 and of as many locking parts 42 which are U-shaped and engage from the inside in the hook-shaped ends of the oil control segments 41 like staples. In their design and arrangement, the contact faces 45 of these essentially correspond to the design and working principle of the locking parts and sealing segments of the second lower segmented ring 10 according to the invention (see FIG. 8). As the formation of the sealing boundary is assured in both the axial and radial direction with the second lower segmented ring 10 in conjunction with the first upper segmented ring 20, one or more oil control segmented rings 40 can be positioned in the same piston ring groove underneath the second lower segmented ring 10 when the formation of a radially effective sealing boundary is assured by the oil control segmented ring or rings 40.

FIG. 11—supplementing FIG. 10—shows an enlarged detail of the oil control ring 40 which in design exploits the interaction of the oil locking parts and the oil control segments when the gas pressure acts in the direction of the central axis of the piston. In their ideal extension, the lateral radial boundary faces of the locking part 42 form a wedge angle pointing with the vertex to the central axis of the piston. Equally, in their ideal extension, the lateral radial boundary faces of the oil control segment 41 facing the boundary faces of the locking part also form a wedge angle pointing with the vertex to the central axis of the piston. Between these two boundary faces there is a gap 48 which can be predetermined by design. Since the working force of the locking part 42 according to the working principle of the first upper segmented ring according to EP 937 216 B1 as a building wedge force is transmitted through the contact faces of the lateral radial boundary faces to the oil control segment 41, the oil control effect is maintained even when there is a vacuum in the working space (7).

The design in which the end faces of the oil control segments 41 widen conically in a bevel 47 relative to the cylinder wall 3, as can be seen in FIG. 4, is advantageous for reduced oil consumption.

### List of References

1. First sealing pack
2. Second sealing pack
3. Cylinder wall
4. Piston
5. Central axis
6. Piston ring groove
7. Working space
8. Bottom of groove
9. Groove
10. Second lower segmented ring
11. Sealing segment
12. Locking part
13. Sealing segment hook
14. Locking part hook
15. Contact face
16. Contact straight line
17. Locking part centre line
18. Sealing segment centre line
19.
20. First upper segmented ring
21. Sealing segment
22. Locking part
23.
24.
25. Contact faces
26. Contact straight line
27. Oil control ring
28, 29.
30. Thrust and locking ring
31. Ring segment
32.
33. Separating face
34.
35. Rotation-preventing locking part
36. Groove
37. Groove
38. Key
39. Groove
40. Oil control segmented ring
41. Oil control segment
42. Locking part
43. Oil control hook
44. Locking part hook
45. Contact face
46. Gap
47. Bevel
48. Gap
49.
50. State of the art segmented ring
51. Sealing segment
52. Locking segment
53. Contact face
α=Locking part wedge angle
β=Sealing segment wedge angle
Θ=Half pitch angle=45°
PF_{ST}=Locking part partial forces
F_{ST}=Locking part pressure force
F_{DS}=Sealing segment pressure force
F_{DSII}=Second working component at sealing segment
F_{DSRes}=Resulting total pressure force at sealing segment
TF=Transmission factor
WRS=Locking part working direction
WRD=Sealing segment working direction

1-14. (canceled)

15. A sealing pack for a reciprocating piston engine and insertable in a circumferential groove in a reciprocating piston of the reciprocating piston engine, the sealing pack comprising:
axially adjoining at least one second (lower) and thereover at least one first (upper) segmented ring having at least two sealing segments and locking parts arranged alternately between them, wherein the sealing segments of the respective first segmented ring cover the locking parts of an axially adjoining segmented ring of the sealing pack, and wherein the sealing segments and the locking parts of the first (upper) segmented ring taper radially inwards in the form of a wedge and the outer arcs of the locking parts are set back slightly radially in contrast to the sealing segments with the outer arc in contact with the wall of the cylinder and extend over a larger area than the sealing segments;
a tapering thrust and locking ring arranged axially above the segmented rings; and
in the case of at least one second (lower) segmented ring the ends of the sealing segments and the locking parts adjoining one another in the circumferential direction engage behind one another radially in the form of hooks, wherein the sealing segments are formed with inwardly pointing hooks and the locking parts are formed with outwardly pointing hooks, and wherein the hooks in each case have a cooperating hooking and contact face that when extended as a contact straight line in the radial direction in each case form a point of intersection on the center line of the locking part and a point of intersection on the center line of the sealing segment that coincide, pointing radially towards the central axis of the ling.

16. The sealing pack according to claim 15, wherein the rotation-preventing locking device makes an interacting connection with at least one locking part of the first segmented ring and a sealing segment of the other segmented ring and comprises at least one tongue and groove connection arranged on the internal circumference of the segmented rings.

17. The sealing pack according to claim 16, wherein the tongue and groove connection comprises in each case of an internal circumferential groove in a lower sealing segment and in the locking part located axially above it and of a key/tongue that engages axially aligned in both grooves of the tongue and groove connection and lies freely in a piston groove.

18. The sealing pack according to claim 15, wherein the pitch angle Θ of a segmented ring structure matches the quotient of the angle π and the number of sealing segments or locking parts of a segmented ring.

19. The sealing pack according to claim 15, wherein the segmented rings are each comprised of four sealing segments and four locking parts.

20. The sealing pack according to claim 15, wherein the thrust and locking ring comprises at least two ring segments and includes surface interruptions, wherein the surface interruptions are one of openings and relief grooves, wherein the surface interruptions are for axial pressure relief in the contact face facing the segmented rings lying axially thereunder.

21. The sealing pack according to claims 17, further comprising an oil control ring of the piston as a bottom oil control segmented ring that includes at least two sealing segments and an equal number of locking parts, wherein the oil control segmented ring is arranged axially underneath the lower second sealing segmented ring in contact with the latter and the piston groove accommodating the sealing pack is correspondingly taller in relation to the thickness of the oil control segmented ring.

22. The sealing pack according to claim 21, wherein the oil control segmented ring comprises in each case four oil control segments and locking parts, the ends of which point in the circumferential direction engage radially behind one another in the form of hooks, with the opposing hook contact faces aligned radially to their own segment central axis.

23. The sealing pack according to claim 22, wherein the locking parts are formed as U-shaped coupling elements, wherein the hook thereof pointing toward a cylinder wall engage radially from the inside outwards in corresponding hook recesses of the oil control segments pointing towards the center point of the ring, with the circumferential end faces of the oil control segment hooks and the oil control segments pointing radially towards the central axis of the ring and adjoining one another essentially parallel with a tiny radial gap.

24. The sealing pack according to claim 23, wherein on their generated surface facing the cylinder wall, the oil control segments of the oil control segmented ring are formed such that they widen conically downwards towards the bottom dead centre (BDC) position of the reciprocating piston in the form of a bevel.

25. The sealing pack according to claim 24, wherein the radially pointing outer boundaries of the locking part include a wedge shape aligned with an ideal wedge vertex pointing towards the center point of the piston and forming a minimal gap to a corresponding contact face in the wedge formed by a neighbouring oil control segment and when force acts in the direction of the axis of the piston comes to bear on the corresponding structure of the oil control segment and presses against the cylinder wall.

26. The sealing pack according to claim 21, wherein the rotation-preventing locking device provided between the sealing segmented rings is adapted to cooperate with the oil control segmented ring, wherein in its at least one oil control segment, a corresponding groove is provided that is adapted so as to be substantially the same and align with the corresponding grooves of the sealing segmented rings located above it, while the key/tongue is formed correspondingly taller in relation to the thickness of the oil control segmented ring.

27. A reciprocating piston for a reciprocating piston engine having at least one circumferential groove on its circumference adapted to receive therein oil control rings or sealing packs for sealing the piston in relation to a wall of a cylinder, the reciprocating piston comprising:
at least one conventional oil control ring situated within a plurality of ring grooves; and
a sealing pack having three segmented rings situated within a ring groove in the reciprocating piston, wherein the sealing pack comprises:
axially adjoining at least one second (lower) and thereover at least one first (upper) segmented ring having at least two sealing segments and locking parts arranged alternately between them, wherein the sealing segments of the respective first segmented ring cover the locking parts of an axially adjoining segmented ring of the sealing pack, and wherein the sealing segments and the locking parts of the first (upper) segmented ring taper radially inwards in the form of a wedge and the outer arcs of the locking parts are set back slightly radially in contrast to the sealing segments with the outer arc in contact with the wall of the cylinder and extend over a larger area than the sealing segments;
a tapering thrust and locking ring arranged axially above the segmented rings; and
in the case of at least one second (lower) segmented ring the ends of the sealing segments and the locking parts adjoining one another in the circumferential direction engage behind one another radially in the form of hooks, wherein the sealing segments are formed with inwardly pointing hooks and the locking parts are formed with outwardly pointing hooks, and wherein the hooks in each case have a cooperating hooking and contact face that when extended as a contact straight line in the radial direction in each case form a point of intersection on the center line of the locking part and a point of intersection on the center line of the sealing segment that coincide, pointing radially towards the central axis of the ring.

28. A reciprocating piston for a reciprocating piston engine having at least one circumferential groove on its circumference adapted to receive therein sealing packs for sealing the piston in relation to a wall of a cylinder, the reciprocating piston having a ring groove containing a sealing pack having four segmented rings, wherein the sealing pack comprises:
axially adjoining at least one second (lower) and thereover at least one first (upper) segmented ring having at least two sealing segments and locking parts arranged alternately between them, wherein the sealing segments of the respective first segmented ring cover the locking parts of an axially adjoining segmented ring of the sealing pack, and wherein the sealing segments and the locking parts of the first (upper) segmented ring taper radially inwards in the form of a wedge and the outer arcs of the locking parts are set back slightly radially in contrast to the sealing segments with the outer arc in contact with the wall of the cylinder and extend over a larger area than the sealing segments;
a tapering thrust and locking ring arranged axially above the segmented rings; and
in the case of at least one second (lower) segmented ring the ends of the sealing segments and the locking parts adjoining one another in the circumferential direction engage behind one another radially in the form of hooks, wherein the sealing segments are formed with inwardly pointing hooks and the locking parts are formed with outwardly pointing hooks, and wherein the hooks in each case have a cooperating hooking and contact face that when extended as a contact straight line in the radial direction in each case form a point of intersection on the center line of the locking part and a point of intersection on the center line of the sealing segment that coincide, pointing radially towards the central axis of the ring.
